(19) United States
(12) Patent Application Publication
(10) Pub. No.: US 2003/0230173 A1
(43) Pub. Date: Dec. 18, 2003

(54) Wrench for selectively driving in one of two opposite directions

(76) Inventor: Terence Chen, Lo Tung Town (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/172,857

(22) Filed: Jun. 17, 2002

(51) Int. Cl. B25B 13/00

(52) U.S. Cl. 81/58

(57) ABSTRACT

A wrench includes a hollow head, a ring received in the hollow head for rotation, first and second brake shoes received in the hollow head for pivoting and a direction controller received in the hollow head between the brake shoes and pivoted between first and second positions. In the first position, the first brake shoe contacts the ring. When rotation of the hollow head relative to the ring in a first direction is attempted, pivoting of the first brake shoe is allowed, thus allowing rotation of the hollow head relative to the ring. When rotation of the hollow head relative to the ring in a second direction is attempted, the direction controller hinders pivoting of the first brake shoe so as to avoid rotation of the hollow head relative to the ring. In the second position, the second brake shoe contacts the ring. When rotation of the hollow head relative to the ring in the second direction is attempted, pivoting of the second brake shoe is allowed, thus allowing rotation of the hollow head relative to the ring. When rotation of the hollow head relative to the ring in the first direction is attempted, the direction controller hinders pivoting of the second brake shoe so as to avoid rotation of the hollow head relative to the ring.

### BACKGROUND OF INVENTION

1. Field of Invention

The present invention is related to a wrench for selectively driving in one of two opposite directions.

2. Related Prior Art

Taiwanese Patent Publication No. 370170 discloses a one-way rotational device with a core 1, a spring 2, a plurality of engagement elements 3 and a drum 4. The core 1 includes a cylindrical periphery on and about which an annular ridge 12 is formed, thus dividing the cylindrical periphery to two sections 11. Each of the engagement elements 3 includes two cams 31 and a shaft 32 formed between the cams 31 and a tunnel 33 transversely extending through the shaft 32. The spring 2 is inserted in the tunnels 33. The shafts 32 are mounted on the annular ridge 12. The contact of the shafts 32 with the annular ridge 12 is retained by means of the spring 2. The core 1 and the engagement elements 3 are received in the drum 4 so that the cams 31 are in slight contact with drum 4. When the core 1 is rotated relative to the drum 4 in a first direction, the engagement elements 3 are rotated relative to the core 1 and the drum 4 by a small angle so that the contact between the cams 31 and the drum 4 becomes slighter. Thus, continuous rotation of the core 1 relative to the drum 4 in the first direction is allowed. When the core 1 is rotated relative to the drum 4 in a second direction opposite to the first direction, the engagement elements 3 are rotated relative to the core 1 and the drum 4 by a relatively large angle so that the contact between the cams 31 and the drum 4 becomes substantial. Thus, continuous rotation of the core 1 relative to the drum 4 in second direction is prohibited. Some problems have been encountered in making and use of this prior art one-way rotational device. Firstly, manufacturing of the engagement elements 3 is difficult and therefore entails a high cost. Secondly, assembling of the elements is complicated and therefore entails a high cost. Thirdly, the spring 2 that is made for extension instead of buckling can be damaged easily since it is buckled whenever rotation of the core 1 relative to the drum 4 in the second direction is attempted.

The present invention is therefore intended to obviate or at least alleviate the problems encountered in prior art.

### SUMMARY OF INVENTION

It is the primary objective of the present invention to provide a wrench that can be switched between a first mode for enhancing engagement of a bolt with a nut and a second mode for disengaging the bolt from the nut.

According to the present invention, a wrench includes a hollow head, a ring received in the hollow head for rotation, first and second brake shoes received in the hollow head for pivoting and a direction controller received in the hollow head between the brake shoes and pivoted between first and second positions. In the first position, the first brake shoe contacts the ring. When rotation of the hollow head relative to the ring in a first direction is attempted, pivoting of the first brake shoe is allowed, thus allowing rotation of the hollow head relative to the ring. When rotation of the hollow head relative to the ring in a second direction is attempted, the direction controller hinders pivoting of the first brake shoe so as to avoid rotation of the hollow head relative to the ring. In the second position, the second brake shoe contacts the ring. When rotation of the hollow head relative to the ring in the second direction is attempted, pivoting of the second brake shoe is allowed, thus allowing rotation of the hollow head relative to the ring. When rotation of the hollow head relative to the ring in the first direction is attempted, the direction controller hinders pivoting of the second brake shoe so as to avoid rotation of the hollow head relative to the ring.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a wrench according to a first embodiment of the present invention;

FIG. 2 is an exploded view of the wrench shown in FIG. 1;

FIG. 3 is a cross-sectional view taken along a line 3-3 in FIG. 1 showing the wrench including a handle, an annular head and a ring;

FIG. 4 is a cross-sectional view taken along a line 4-4 in FIG. 1 showing the annular head allowed to rotate relative to the ring in a direction;

FIG. 5 is similar to FIG. 4 except for showing the ring in another position;

FIG. 6 is similar to FIG. 4 except for showing the annular head allowed to rotate relative to the ring in an opposite direction;

FIG. 7 is similar to FIG. 6 except for showing the ring in another position;

FIG. 8 is a perspective view of a wrench according to a second embodiment of the present invention.

### DETAILED DESCRIPTION OF EMBODIMENTS

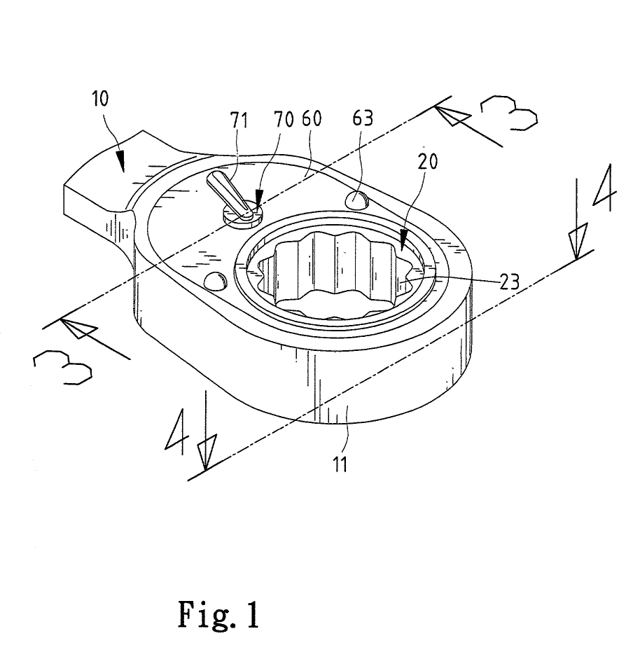

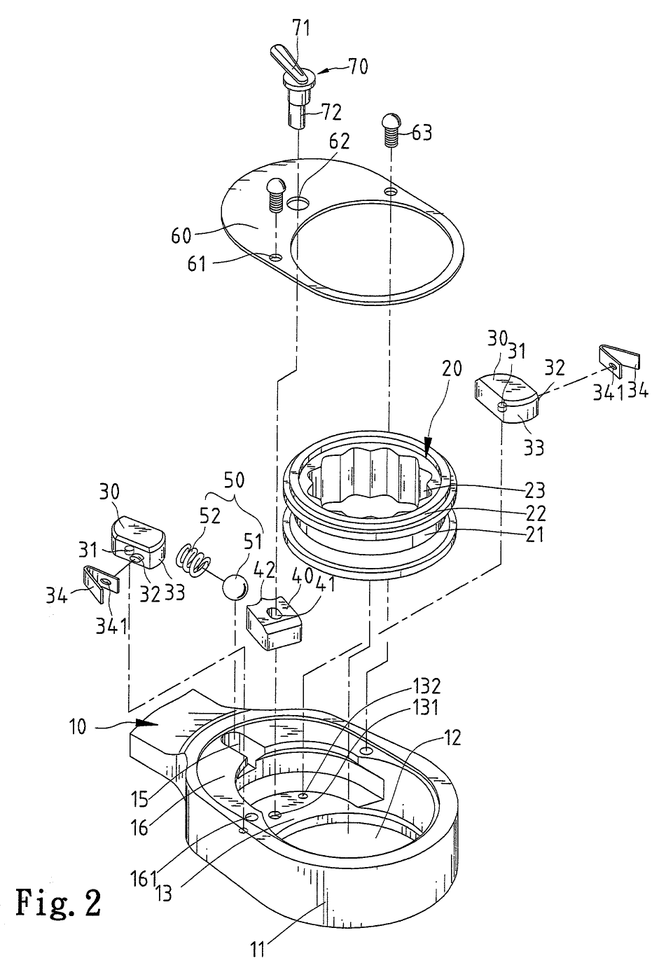

Referring to FIGS. 1 and 2, according to a first embodiment of the present invention, a wrench 10 includes a head 11. The head 11 includes a lower plate 13 formed thereon, an upper plate 16 formed thereon and a space 12 defined therein between the lower plate 13 and the upper plate 16. The lower plate 13 defines a circular opening. A positioning aperture 131 and two locking apertures 132 are defined in the lower plate 13. The upper plate 16 defines an opening including a first portion and a second portion with a diameter less than that of the first portion. The upper plate 16 defines a cutout 15 in communication with the second portion of the opening defined therein. Two apertures 161 are defined in the upper plate 16. The space 12 includes a first portion and a second portion with a diameter less than that of the first portion. The first portion of the opening defined in the lower plate 13 is smaller than the first portion of the space 12. The second portion of the opening defined in the upper plate 16 is smaller than the second portion of the space 12.

A ring 20 is shaped like a pulley, i.e., it includes an external face 21 between two end plates (not numbered) and two rims 22 each formed on one of the end plates thereof. The ring 20 includes a toothed internal face 23 for engagement with a nut or a head of a bolt. The ring 20 is received in the first portion of the space 12. One of the rims 22 is received in the opening defined in the lower plate 13. Thus, the ring 20 is allowed to rotate relative to the head 11.

The wrench 10 includes two brake shoes 30. Each of the brake shoes 30 includes an end 33 for contact with the external face of the ring 20, a bottom on which a boss 31 is formed, a first side on which a boss 32 is formed and a second side for contact with a direction controller 40 to be described. The brake shoes 30 are received in the second portion of the space 12. The boss 31 of each of the brake shoes 30 is received in one of the positioning apertures 132, thus allowing the brake shoes 30 to pivot relative to the lower plate 13.

The wrench 11 includes two bent leaf springs 34 each including a first section and a second section defining an aperture 341. The boss 32 of each of the brake shoes 30 is received in the aperture 341 defined in one of the bent leaf springs 34. The bent leaf springs 34 are also received in the second portion of the space 12. Each of the bent leaf springs 34 is compressed between one of the brake shoes 30 and an internal face of the ring 20.

The direction controller 40 includes a top in which a non-circular recess 41 is defined, two sides and an end in which two recesses 42 are defined. The direction controller 40 is received in the second portion of the space 12 between the brake shoes 30.

A direction retainer 50 includes a ball 51 and a spring 52. The spring 52 is received in the cutout 15. A ball 51 is partially received in the cutout 15 against the spring 52, and is partially received one of the recesses 42 defined in the direction controller 40.

A cover 60 defines an opening identical to the opening defined in the lower plate 13, two apertures 61 and an aperture 62. The cover 60 is mounted on the head 11 so that the remaining one of the rims 22 is received in the aperture 62. Two bolts 63 are inserted through the apertures 61 and then driven into the apertures 161, thus securing the cover 60 to the head 11.

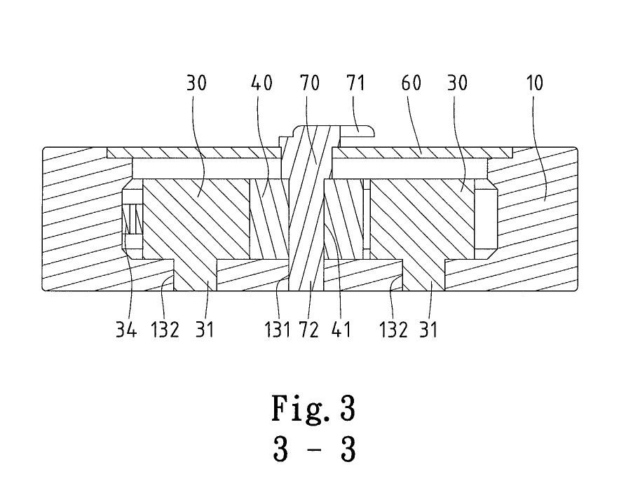

Referring to FIGS. 2 and 3, a switch 70 includes a lever 71 and a rod 72 projecting from the lever 71. The rod 72 is inserted through the aperture 62 into the recess 41 defined in the direction controller 40. Thus, the lever 71 can be operated in order to pivot the direction controller 40.

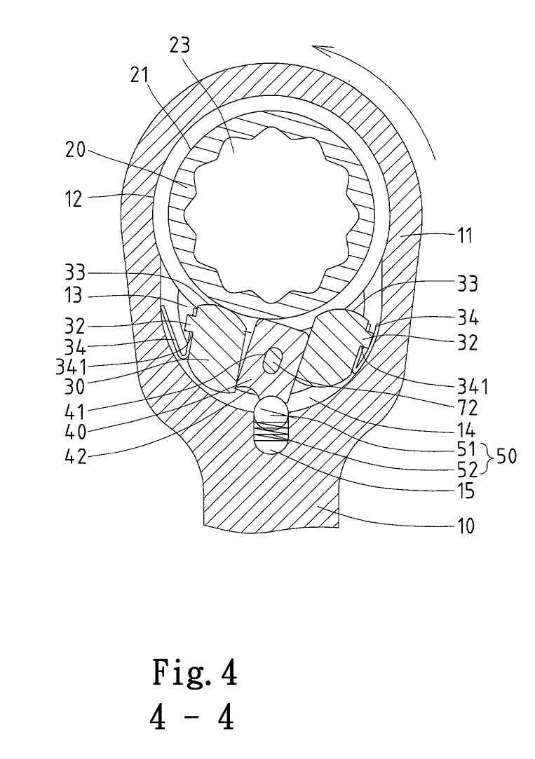

FIGS. 4˜7 show how the wrench can be operated. Although not shown in these figures, it should be borne in mind that the ring 20 is engaged with a nut or a head of a bolt in operation.

Referring to FIG. 4, the lever 71 is operated so as to pivot the direction controller 40 clockwise. The direction controller 40 causes the brake shoes 30 to pivot clockwise so that the end 33 of the brake shoe 30 on the left contacts the external face of the ring 21. The ball 51 biased by the spring 52 is partially received in the recess 42 on the right in order to retain the direction controller 40. When counterclockwise rotation of the head 11 relative to the ring 20 is attempted, counterclockwise pivoting of the brake shoe 30 on the left is allowed due to the spring 34 on the left. Thus, friction between the end 33 of the brake shoe 30 on the left and the external face 22 of the ring 20 is reduced, and the end 33 of the brake shoe 30 on the left is allowed to slide on the external face 22 of the ring 20. Therefore, the head 11 is allowed to rotate relative to the ring 20 counterclockwise.

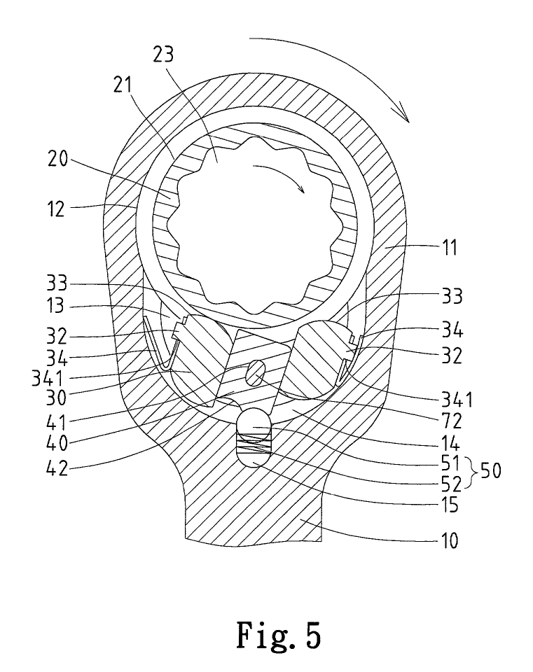

Referring to FIG. 5, when clockwise rotation of the head 11 relative to the ring 20 is attempted, the brake shoe 30 on the left is pressed against the direction controller 40. Thus, the friction between the end 33 of the brake shoe 30 and the external face 22 of the ring 20 is increased, and the end 33 of the brake shoe 30 on the left is not allowed to slide on the external face 22 of the ring 20. Therefore, the head 11 is not allowed to rotate relative to the ring 20 clockwise. That is, the ring 20 is rotated together with the head 11.

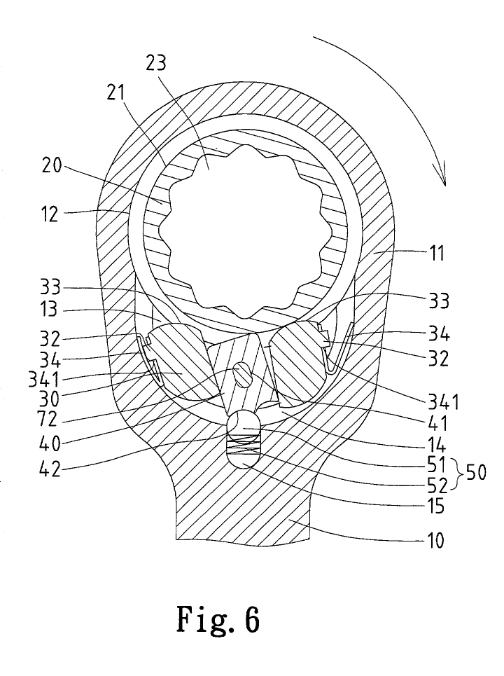

Referring to FIG. 6, the lever 71 is operated so as to pivot the direction controller 40 counterclockwise. The direction controller 40 causes the brake shoes 30 to pivot counterclockwise so that the end 33 of the brake shoe 30 on the right contacts the external face of the ring 21. The ball 51 biased by the spring 52 is partially received in the recess 42 on the left in order to retain the direction controller 40. When clockwise rotation of the head 11 relative to the ring 20 is attempted, clockwise pivoting of the brake shoe 30 on the right is allowed due to the spring on the right. Thus, friction between the end 33 of the brake shoe 30 on the right and the external face 22 of the ring 20 is reduced, and the end 33 of the brake shoe 30 on the right is allowed to slide on the external face 22 of the ring 20. Therefore, the head 11 is allowed to rotate relative to the ring 20 clockwise.

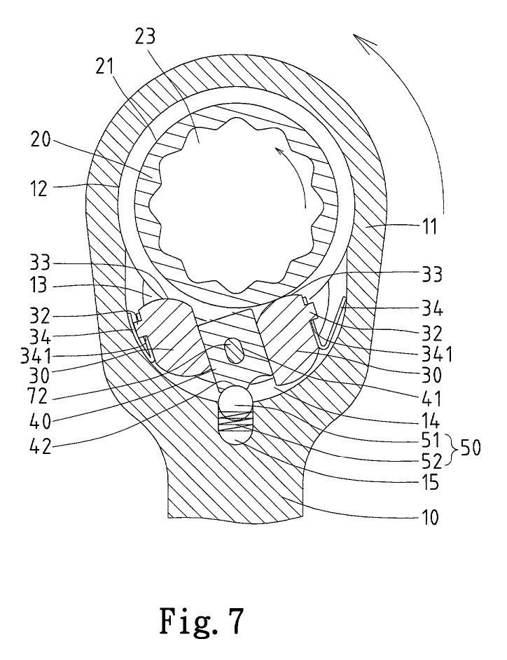

Referring to FIG. 7, when counterclockwise rotation of the head 11 relative to the ring 20 is attempted, the brake shoe 30 on the right is pressed against the direction controller 40. Thus, the friction between the end 33 of the brake shoe 30 on the right and the external face 22 of the ring 20 is not reduced. Thus, the end 33 of the brake shoe 30 on the left is not allowed to slide on the external face 22 of the ring 20. Therefore, the head 11 is not allowed to rotate relative to the ring 20 clockwise. That is, the ring 20 is rotated together with the head 11.

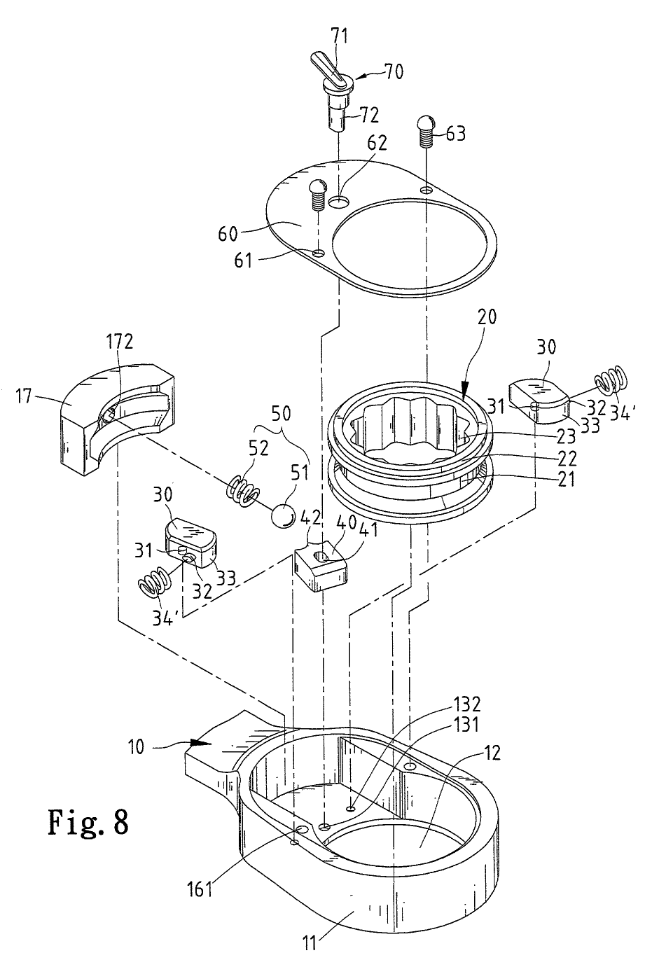

FIG. 8 shows a second embodiment of the present invention identical to the first embodiment except for some features. Firstly, the second embodiment does not include an upper plate 16. Secondly, the second embodiment includes a block 17 defining a recess 172 for receiving the spring 52 and a part of the ball 50. Thirdly, the head 11 defines a space 12′ including a larger second portion for receiving the block 17. Fourthly, the leaf springs 34 are replaced with two helical springs 34′.

The resent invention has been described through detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

1. A wrench including a hollow head (11), a ring (20) received in the hollow head (11) for rotation, first and second brake shoes (30) received in the hollow head (11) for pivoting and a direction controller (40) received in the hollow head (11) between the brake shoes (30) and pivoted between first and second positions, wherein in the first position, the first brake shoe (30) contacts the ring (20) so that when rotation of the hollow head (11) relative to the ring (20) in a first direction is attempted, pivoting of the first brake shoe (30) is allowed, thus allowing rotation of the hollow head (11) relative to the ring (20), and that when rotation of the hollow head (11) relative to the ring (20) in a second direction is attempted, the direction controller (40) hinders pivoting of the first brake shoe (30) so as to avoid rotation of the hollow head (11) relative to the ring (20), and in the second position, the second brake shoe (30) contacts the ring (20) so that when rotation of the hollow head (11) relative to the ring (20) in the second direction is attempted, pivoting of the second brake shoe (30) is allowed, thus allowing rotation of the hollow head (11) relative to the ring (20), and that when rotation of the hollow head (11) relative to the ring (20) in the first direction is attempted, the direction controller (40) hinders pivoting of the second brake shoe (30) so as to avoid rotation of the hollow head (11) relative to the ring (20).

2. The wrench according to claim 1 including a position retainer (50) received in the hollow head (11) for selectively retaining the direction controller (40) in one of the first and second positions.

3. The wrench according to claim 2 wherein the direction controller (40) includes two recesses (42) defined in an end, and the direction retainer (50) includes a ball (51) for selectively engagement with one of the recesses (42) and a spring (52) for biasing the ball (51).

4. The wrench according to claim 1 including two springs (34; 34′) for biasing the brake shoes (30).

5. The wrench according to claim 4 wherein each of the spring is a bent leaf spring (34) including a first section in contact with the hollow head (11) and a second section in contact with one of the brake shoes (30).

6. The wrench according to claim 5 wherein each of the brake shoes (30) includes a boss (32) formed thereon, and the second section of each of the bent leaf springs (34) defines an aperture (341) for receiving the boss (32) formed on one of the brake shoes (30).

7. The wrench according to claim 4 wherein each of the spring is a helical spring (34′) including a first end in contact with the hollow head (11) and a second end in contact with one of the brake shoes (30).

8. The wrench according to claim 7 wherein each of the brake shoes (30) includes a boss (32) formed thereon and received in the second end of one of the helical springs (34′).

9. The wrench according to claim 1 including a switch (70) for switching the direction controller (40) between the first and second positions.

10. The wrench according to claim 9 wherein the switch (70) includes a lever (71) for easy pivoting and a rod (72) projecting from the lever (71) into engagement with the direction controller (40).

11. The wrench according to claim 10 wherein the direction controller (40) defines a non-circular recess (41) for receiving a compliant end of the rod (72).
